(19) United States
(12) Patent Application Publication
(10) Pub. No.: US 2021/0186069 A1
(43) Pub. Date: Jun. 24, 2021

(54) Hummus-Like Food and Production Method Therefor

(71) Applicant: Golden Mustard Corporation, Chiyoda-ku Tokyo (JP)

(72) Inventor: Taichiro KITAYAMA, Tokyo (JP)

(21) Appl. No.: 17/192,915

(22) Filed: Mar. 5, 2021

Related U.S. Application Data
(63) Continuation-in-part of application No. PCT/JP2018/041096, filed on Nov. 6, 2018.

(51) Int. Cl. A23L 11/00; A23L 7/10; A23L 25/00

(52) U.S. Cl. CPC A23L 11/05; A23L 7/10; A23V 2002/00; A23L 11/07; A23L 25/30

(57) ABSTRACT

A hummus-like food has a base; the base has sake lees and has soy pulp and/or ground soybeans; fractional water content of the base is within a range that is 30% to 95%; and a wt % ratio of the sake lees to the soy pulp and/or ground soybeans present within solids content of the base is within a range that is 80:20 to 5:95.

### CROSS-REFERENCE TO RELATED APPLICATION, BENEFIT CLAIM, AND INCORPORATION BY REFERENCE

This application is a continuation-in-part of and claims benefit under 35 USC 120 and 365(c) to copending International Application No. PCT/JP2018/041096, entitled “Hummus-Like Food and Production Method Therefor”, filed 6 Nov. 2018, the content of which is hereby incorporated herein in its entirety by reference.

### FIELD OF THE INVENTION

The present invention relates to a hummus-like food and a production method therefor. More particularly, the present invention relates to a hummus-like food employing sake lees as base, and to a production method therefor.

### BACKGROUND

There is a food called hummus which is known in the Middle East and elsewhere. Hummus is a food that may employ mashed chickpeas (hereinafter referred to as “chickpea paste”) as base, to which food oil, tahini (sesame paste), lemon juice, garlic, spices, and the like may be added. The chickpea paste base may constitute the major part (e.g., on the order of 50% to 90% of the entirety) of the constituents that make up hummus. Hummus is typically eaten in the form of a dip, sauce, or the like for bread and so forth. As hummus has high nutritional value, it is loved by many people all over the world, and by vegetarians in particular. The reason for this is that the chickpeas which make up the base are a highly nutritious foodstuff of high mineral content that is rich in protein and dietary fiber.

Because chickpeas have a crumbly food texture like chestnuts and potatoes, and because they are amenable to seasoning, inasmuch as their flavor is not overpowering, they are a foodstuff that is extremely well-suited for use as a processed food, and in particular for being made into a paste which is used as a base of a dip or sauce such as hummus or the like.

However, because cultivation of chickpeas is difficult in rainy and humid locations, the regions in which they can be cultivated are limited. In particular, cultivation of chickpeas is difficult is Japan and other regions in which rainy seasons are prevalent. This being the case, the regions in which hummus, which often employs chickpea paste as base, can be inexpensively produced in stable fashion are limited. For this reason, development of a food, having a crumbly food texture and not having any overpowering flavor, such as might serve as a base for hummus has been desired.

On the other hand, sake lees are the residue (dregs) that may be obtained from operations for manufacture of Japanese sake. Because sake lees are a fermented food and because the raw material from which sake lees are made is rice, sake lees are of extremely high nutritional value. But because of the overpowering taste and flavor of sake lees, they do not lend themselves to use in processed foods and so forth, and there is not enough demand to justify going to the trouble to process that which is produced as a byproduct of Japanese sake manufacturing operations. For this reason, the current situation is that most of the sake lees that are produced undergoes processing as industrial waste.

Similarly, soy pulp is the residue produced during operations for manufacture of tofu. Because the raw material from which soy pulp is made is soybeans and because soy pulp is rich in vegetable fiber, soy pulp is of extremely high nutritional value. But because soy pulp has poor food texture and so forth, there is not enough demand to justify going to the trouble to process that which is produced as a byproduct of tofu manufacturing operations. For this reason, the current situation is that most of that which is produced is treated as industrial waste.

It is therefore an object in accordance with one aspect of the present invention to provide a hummus-like food, the flavor and food texture of which are similar to hummus which employs chickpea paste as base. An object in accordance with another aspect of the present invention is to provide a foodstuff that will allow good use to be made of sake lees and/or soy pulp that might otherwise go to waste.

### SUMMARY OF INVENTION

As a result of intensive research with the goal of achieving the foregoing and/or other objects, the present inventor arrived at the discovery of the present invention which may employ inexpensive foodstuffs in the base but which has flavor and food texture similar to those of hummus which employs chickpea paste as base.

Aspect and embodiments of the present invention may include:

(1) A hummus-like food having a base; wherein the base has sake lees and has soy pulp and/or ground soybeans; wherein fractional water content of the base is within a range that is 30% to 95%; and wherein a wt % ratio of the sake lees to the soy pulp and/or ground soybeans present within solids content of the base is within a range that is 80:20 to 5:95;

(2) The hummus-like food according to (1) wherein the fractional water content of the base is within a range that is 70% to 90%; and the wt % ratio of the sake lees to the soy pulp and/or ground soybeans present within the solids content of the base is within a range that is 65:35 to 10:90, and is more preferably 65:35 to 30:70;

(3) The hummus-like food according to (2) wherein the wt % ratio of the sake lees to the soy pulp and/or ground soybeans present within the solids content of the base is within a range that is 50:50 to 30:70;

(4) The hummus-like food according to (3) wherein the wt % ratio of the sake lees to the soy pulp and/or ground soybeans present within the solids content of the base is 40:60;

(5) The hummus-like food according to any of (1) through (4) further comprising food oil; wherein content of the food oil as a fraction of overall weight is within a range that is 20% to 40%;

(6) The hummus-like food according to (5) further comprising tahini (sesame paste) and a tartness-imparting substance;

(7) The hummus-like food according to any of (1) through (6) wherein the base does not contain chickpeas or does not contain chickpeas that have been made into a paste; and/or

(8) A production method for a hummus-like food, the production method comprising an operation in which sake lees are heated and agitated; an operation in which the sake lees are kneaded together with soy pulp and/or ground soybeans, and fractional water content is adjusted so as to be within a range that is 30% to 95%, to produce a base; and an operation in which food oil is kneaded into the base.

### BENEFIT OF INVENTION

Some embodiments of the present invention make it possible to provide a hummus-like food which employs sake lees as well as soy pulp and/or ground soybeans in the base but which has flavor and food texture similar to those of hummus.

### BRIEF DESCRIPTION OF DRAWINGS

Many aspects of the invention can be better understood with reference to the following drawings.

FIG. 1 shows results of sensory evaluation testing carried out with respect to wt % ratio in base.

FIG. 2 shows results of sensory evaluation testing carried out with respect to the blended amount of food oil.

### DETAILED DESCRIPTION

One embodiment of the present invention is a hummus-like food, the food texture and flavor of which are similar to those of hummus.

### Hummus

Description will first be given with respect to what is referred to herein as hummus. Hummus is a paste- or spread-like processed food that employs chickpea paste as base, to which food oil, lemon juice, tahini (sesame paste), garlic, spices, and the like may be added. Characteristic of hummus is the soft crumbly food texture of the chickpea paste which serves as base, and the flavors of the tahini, garlic, spices, and so forth that may be added to the base. This is because chickpea paste generally does not have an overpowering taste or smell but rather has the delicate aroma of beans, which is what allows it to faithfully convey the flavors of the tahini, garlic, spices, and so forth that may be added to the base.

### Hummus-Like Food

A hummus-like food associated with one aspect of the present invention is described below. In accordance with one embodiment, a hummus-like food may contain a base, food oil, vinegar, lemon juice, and tahini (sesame paste). The taste, flavor, and so forth of the hummus-like food of this embodiment may be adjusted through use of salt, pepper, spices, other foodstuffs, and so forth.

### Base

In accordance with one embodiment, the base has sake lees and has soy pulp and/or ground soybeans. Stating this another way, the base in such an embodiment may be obtained by kneading sake lees with soy pulp and/or ground soybeans. The fractional water content of the base in such an embodiment may be within the range 30% to 95%. It is preferred that the fractional water content of the base in such an embodiment be 70% to 90%. The fractional water content of the base in such an embodiment may be adjusted by adding water and/or the like. Note that water, soy milk, cow's milk, and/or other such water-soluble flavoring, alcoholic beverage, and/or the like may be used for adjustment of the fractional water content in such an embodiment.

In accordance with one embodiment, the wt % ratio of that portion of the solids content of the base which is attributable to sake lees versus that which is attributable to soy pulp and/or ground soybeans may be in the range 80:20 to 5:95. It is preferred that the wt % ratio of the portion of the solids content of the base which is attributable to sake lees versus that which is attributable to soy pulp and/or ground soybeans be in the range 65:35 to 10:90, and particularly preferred that this be in the range 50:50 to 30:70. It is even more preferred that the wt % ratio of the portion of the solids content of the base which is attributable to sake lees versus that which is attributable to soy pulp and/or ground soybeans be 40:60.

### Sake Lees

Sake lees, as referred to herein, are the residue (dregs) that may be obtained from operations for manufacture of regular sake, honjuzo sake, ginjo sake, daiginjo sake, and/or other such types of Japanese sake. While the sake lees employed herein may be in sheet (solid) form, liquid or dried sake lees, or any other suitable form thereof, may alternatively or additionally be used.

For every 100 g of the edible portion thereof, typical (solid) sake lees might, for example, contain 51.1 g of water, 8.2 g of alcohol, 14.9 g of protein, 1.5 g of fat, 23.8 g of carbohydrates (5.2 g of dietary fiber), and 0.5 g of ash (Standard Tables of Food Composition in Japan, 2015 Edition). Throughout the present specification, the content of sake lees exclusive of its water content and alcohol content is referred to as the solids content thereof. Furthermore, throughout the present specification, moisture content (water content) and fractional moisture content (fractional water content) should be understood to include alcohol content.

Soy Pulp and/or Ground Soybeans

Soy pulp, as referred to herein, is the residue produced during operations for manufacture of tofu. More specifically, soy pulp is the residue that remains after soy milk and other water content has been extracted from soybeans which have been heated and ground (ground soybeans). While soy pulp is sometimes used in a state (raw soy pulp) in which it still contains some moisture following extraction of the water content therefrom, it is often the case that the raw soy pulp is first dried and this is then distributed and sold as dried soy pulp.

Because the raw material from which it is made is soybeans and because it is rich in vegetable fiber, soy pulp is of extremely high nutritional value. But because soy pulp has poor food texture and so forth, there is not enough demand to justify going to the trouble to process that which is produced as a byproduct of tofu manufacturing operations. For this reason, the current situation is that most of that which is produced is treated as industrial waste.

For every 100 g of the edible portion thereof, the constitution of typical raw soy pulp might, for example, be such that it contains 75.5 g of water, 6.1 g of protein, 3.6 g of fat, 13.8 g of carbohydrates (11.5 g of dietary fiber), and 1.0 g of ash; for every 100 g of the edible portion thereof, the constitution of dried soy pulp is such that it typically contains 7.1 g of water, 23.1 g of protein, 13.6 g of fat, 52.3 g of carbohydrates (43.6 g of dietary fiber), and 3.8 g of ash (Standard Tables of Food Composition in Japan, 2015 Edition).

Ground soybeans, as referred to herein, are what is obtained when reconstituted soybeans (dried soybeans to which water has been added), fresh soybeans, defatted soybean meal, and/or other such processed soybean product, is heated and ground. In accordance with the present embodiment, ground soybeans may be used in the base instead of or in addition to soy pulp.

Soy matter is used herein as a general term to include soy pulp and/or ground soybeans. That is, soy pulp is one specific example of what is referred to herein as soy matter, and ground soybeans is another specific example of what is referred to herein as soy matter. Note that soy matter in some embodiments may include both soy pulp and ground soybeans.

### Food Oil

So long as it is suitable for food use, any oil may be used as the food oil which may be employed herein. For example, olive oil, rapeseed oil, corn oil, cottonseed oil, soybean oil, palm oil, egg yolk oil, and so forth may be employed, there being no restriction with regard to the type of raw material employed. And any degree of refining—e.g., pure oil, semi-refined oil, refined oil, salad oil, and/or the like—is acceptable.

### Tahini

Tahini (sesame paste), as referred to herein, is sesame that has been ground into a paste. While tahini might, for example, typically be raw sesame that has been made into a paste, the reason that the present specification sometimes puts sesame paste in parentheses, referring to this as “(sesame paste),” is that the sesame that is made into a paste is not limited to raw sesame but may include that which has been heated (what is referred to as sesame butter). Furthermore, in accordance with the present embodiment, there is no restriction with regard to the type of sesame employed. Furthermore, alternative foodstuffs and/or processing ingredients may be used instead of or in addition to tahini (sesame paste). For example, in some embodiments ground sesame seeds and/or other such sesame products may be used, and in some embodiments mayonnaise and/or other such flavorings and/or additives may be added thereto.

### Tartness

For tartness, vinegar or lemon juice, or a mixture thereof, may be added. Any type of vinegar may be employed; for example, grain vinegar, rice vinegar, black vinegar, apple cider vinegar, balsamic vinegar, wine vinegar, and so forth. Furthermore, what is referred to herein as lemon juice may be juice obtained by squeezing a fresh lemon or may be that which is commercially available. Moreover, instead of vinegar and/or lemon juice, juice such as that which may be obtained from a citrus fruit other than lemon or other such fruit or the like and/or commercially available juice(s) may be employed.

### Other Flavorings

In accordance with the present embodiment, flavorings, spices, and/or the like similar to those added to hummus may be added to the hummus-like food. For example, any among the following may be added thereto alone, or a plurality chosen from thereamong may be added thereto in combination: grated garlic and/or other such fragrant vegetables, basil, parsley, rosemary, and/or other such herbs, peppers, garlic powder, cumin seeds, garam masala, cinnamon, curry powder, wasabi, and/or other such spices. Furthermore, thickeners, fragrances, condiments, colorants, antioxidants, and/or other such food substances and/or food additives may be employed.

In accordance with the present embodiment, note that legumes other than soybeans, or processed goods made therefrom, may be used as raw material instead of or in addition to ground soybeans and/or soy pulp. Furthermore, in accordance with the present embodiment, there is no restriction with regard to whether or not the base contains chickpeas (chickpea paste). However, it is preferred that the base not contain chickpeas (chickpea paste).

### Manufacturing Method

An example of a manufacturing method in accordance with the present embodiment is described below. The present example employs dried soy pulp and sake lees in sheet (solid) form in the base.

(1) Sake lees are heated while being subjected to agitation. At such time, water may be added if necessary. By applying heat while agitating, it is possible to obtain viscous sake lees. It is preferred that the fractional water content of the sake lees following heating be on the order of 50% to 95%.

(2) Water is added to dried soy pulp. While there is no restriction with regard to the temperature of the water, to prevent proliferation of bacteria it is preferred that it has been boiled. Adjustment of fractional water content is carried out by adding water and/or by causing evaporation as a result of application of heat or the like. It is preferred that the fractional water content of the soy pulp be on the order of 20% to 80%.

(3) The sake lees from (1) and the soy pulp from (2), the fractional water contents of which have been adjusted, are kneaded together. The fractional water content of the base may be adjusted so as to be within the range 30% to 95%. It is preferred that the fractional water content of the base be adjusted so as to be on the order of 40% to 90%.

(4) Food oil and tahini (sesame paste) are added to the base from (3), and this is further kneaded. More specifically, this is ground and agitated in an agitator (mixer). This may be filtered as necessary. Filtering will allow the food texture thereof to be made smooth.

(5) Vinegar, lemon juice, flavorings, spices, and the like are added to that which was obtained at (4), and this is further kneaded.

Note that the foregoing is merely one example of a manufacturing method. The manufacturing method associated with the present embodiment is not limited to this example.

For example, whereas in the present example the water contents of the sake lees and the soy pulp were respectively adjusted at (1) and (2), it is also possible not to individually adjust the water contents thereof but to knead the sake lees and soy pulp together and instead adjust the overall water content of the base. But by first causing the sake lees to be heated and agitated and the fractional water content thereof to be adjusted as in the present example, it will be possible to make the sake lees viscous. Because the viscosity of the soy pulp at (2) is low, causing the soy pulp to be kneaded with viscous sake lees will make it possible to form the base in such fashion that the entirety holds together well.

At the foregoing example, after kneading the sake lees and soy pulp together to produce the base, food oil and tahini (sesame paste) are added to the base and this is kneaded. However it is also possible to add the food oil and tahini (sesame paste) at the time that the base is produced, and to cause these all to be kneaded together. It is also possible to cause all of the substances to be kneaded together in one operation.

The foregoing is an example that employs soy pulp. However, ground soybeans may be used instead of or in addition to soy pulp. Furthermore, regarding the other materials as well, any of the materials mentioned above may be used.

As described above, by causing the base thereof to employ sake lees and employ soy pulp and/or ground soybeans, by causing the wt % ratio of the portion of the solids content of the base which is attributable to sake lees versus that which is attributable to soy pulp and/or ground soybeans to be adjusted, and by causing the fractional water content thereof to be adjusted, it is possible to cause the hummus-like food associated with the present embodiment to have a flavor which is similar to that of hummus.

By causing the wt % ratio of the sake lees to the soy pulp and/or ground soybeans to be adjusted, it is possible to cause the odor which is characteristic of sake lees, and the soybean smell which is characteristic of soy pulp (or ground soybeans), to cancel each other out, and to produce a flavor that is not overpowering and that is like that of chickpeas which have been made into a paste.

Furthermore, adjustment of this wt % ratio makes it possible to obtain a soft crumbly food texture like that of chickpeas which have been made into a paste. This is because causing sake lees which is viscous to be kneaded with soy pulp and/or ground soybeans which is creamy yet suitably fibrous makes it possible to obtain a food texture that is smooth and feels good on the tongue and that is like chickpeas which have been made into a paste.

As described above, hummus is a food that has high nutritional value, and is loved by many people all over the world, and by vegetarians in particular. As a result of using substances that are highly nutritious, i.e., sake lees as well as soy pulp and/or ground soybeans, the hummus-like food associated with the present embodiment is able to provide a food of high nutritional value that is not inferior to that of hummus.

Furthermore, the raw material from which sake lees are made is rice, and the raw material from which soy pulp (ground soybeans) is made is soybeans. For this reason, the hummus-like food associated with the present embodiment is a food that like hummus is capable of being eaten by vegetarians.

Moreover, sake lees and soy pulp are residues which are produced during operations for manufacture of Japanese sake and tofu, most of which undergoes processing as industrial waste. This being the case, this will make it possible to expand the uses and applications of sake lees and soy pulp to a hummus-like food loved by people all over the world, to reduce industrial waste, and to achieve an ecological society.

### WORKING EXAMPLES

Results of various types of tests performed on working examples associated with the present embodiment are presented below.

TABLE 1 shows working examples and comparative examples in which there were a plurality of fractional weight values of materials employed in the base and fractional weight values thereof as found in solids content. Note that Working Examples 1 through 9 and Comparative Examples 1 and 2 were examples which employed dried soy pulp and sake lees in sheet form (containing approximately 51% water and approximately 8% alcohol) as materials for the base. Note that the values given for fractional weights in solids content are the wt % values of the various materials as found in the solids contents. Furthermore, the fractional water contents of the bases at Working Examples 1 through 9 and Comparative Examples 1 and 2 were adjusted so as to be approximately 80%.

Furthermore, TABLE 1 shows the flavor and food texture of each of the working examples and each of the comparative examples as evaluated by the inventor. Here, bases having blended amounts in accordance with the respective working examples and the respective comparative examples were prepared, and evaluation of flavor was carried out by determining whether or not these had little flavor such as would be the case with chickpea paste. In other words, evaluation was carried out to determine whether or not the odor which is characteristic of sake lees and the odor which is characteristic of soy pulp had been eliminated. Regarding food texture, evaluation was carried out to determine whether or not the food texture was close to that of chickpeas which have been made into a paste. In other words, evaluation was carried out to determine whether or not the wet texture which is characteristic of sake lees and the dry texture which is characteristic of soy pulp had been eliminated, and whether there was a soft crumbliness like that of chickpeas. The meanings of the symbols used in the table are: VG=very good; G=good; OK=neither acceptable nor unacceptable; NG=bad.

TABLE 1

| | Working Example 1 | | Working Example 2 | | Working Example 3 | |
|---|---|---|---|---|---|---|
| | Fractional | Fractional weight in | Fractional | Fractional weight in | Fractional | Fractional weight in |
| | weight | solids content | weight | solids content | weight | solids content |
| | (wt %) | (wt %) | (wt %) | (wt %) | (wt %) | (wt %) |
| Sake lees | 90 | 80 | 80 | 65 | 70 | 50 |
| Soy pulp (dried) | 10 | 20 | 20 | 35 | 30 | 50 |
| Flavor | OK | | G | | G | |
| Food texture | OK | | G | | G | |
| | Working Example 4 | | Working Example 5 | | Working Example 6 | |
| | Fractional | Fractional weight in | Fractional | Fractional weight in | Fractional | Fractional weight in |
| | weight | solids content | weight | solids content | weight | solids content |
| | (wt %) | (wt %) | (wt %) | (wt %) | (wt %) | (wt %) |
| Sake lees | 60 | 40 | 50 | 30 | 40 | 23 |
| Soy pulp (dried) | 40 | 60 | 50 | 70 | 60 | 77 |
| Flavor | VG | | G | | G | |
| Food texture | VG | | G | | G | |
| | Working Example 7 | | Working Example 8 | | Working Example 9 | |
| | Fractional | Fractional weight in | Fractional | Fractional weight in | Fractional | Fractional weight in |
| | weight | solids content | weight | solids content | weight | solids content |
| | (wt %) | (wt %) | (wt %) | (wt %) | (wt %) | (wt %) |
| Sake lees | 30 | 15 | 20 | 10 | 10 | 5 |
| Soy pulp (dried) | 70 | 85 | 80 | 90 | 90 | 95 |

| | | | |
|---|---|---|---|
| Flavor | G | G | OK |
| Food texture | G | G | OK |

| | Comparative Example 1 | | Comparative Example 2 | |
|---|---|---|---|---|
| | Fractional | Fractional weight in | Fractional | Fractional weight in |
| | weight | solids content | weight | solids content |
| | (wt %) | (wt %) | (wt %) | (wt %) |
| Sake lees | 100 | 100 | 0 | 0 |
| Soy pulp (dried) | 0 | 0 | 100 | 100 |

| | | |
|---|---|---|
| Flavor | NG | NG |
| Food texture | NG | NG |

As noted above, the fractional water contents of the bases in Working Examples 1 through 9 and Comparative Examples 1 and 2 shown in TABLE 1 were adjusted so as to be approximately 80%. Moreover, upon performing additional testing under conditions similar to those at TABLE 1 but in which fractional water content of the base was varied over a wide range, it was found that the results obtained were similar to the results at TABLE 1 when fractional water content of the base was within the range 70% to 90%. The results shown in TABLE 1 and the results obtained during this additional testing may be summarized as follows. While it was observed that food texture was evaluated as being of somewhat dry texture or the like when fractional water content of the base was low (roughly within the range 30% to 65%), and while it was observed that food texture was evaluated as being somewhat watery or the like when fractional water content was high (roughly 95%), it was nevertheless found that a base of adequate flavor and food texture, these being akin to those of chickpea paste, could be obtained when the fractional water content of the base was within the range 30% to 95%.

Results of Sensory Evaluation Testing Carried Out with Respect to Wt % Ratio in Base of Hummus-Like Food

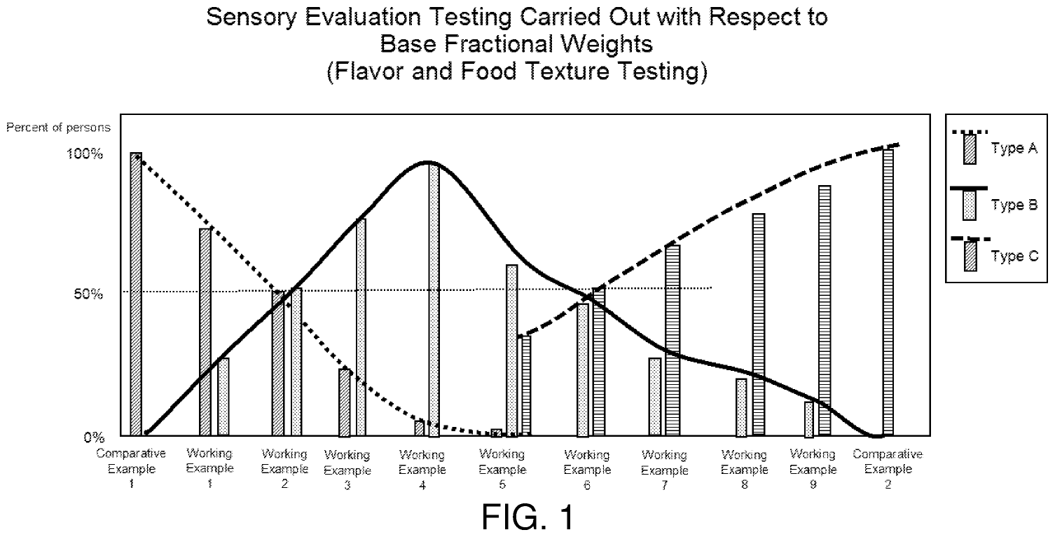

Sensory evaluation testing was carried out with respect to the wt % ratio in the base. FIG. 1 shows results of sensory evaluation testing carried out with respect to the wt % ratio in the base of the hummus-like food.

At this sensory evaluation testing, 11 types of food samples comprising hummus-like food having bases in accordance with Working Example 1 through 9 and Comparative Examples 1 and 2 were prepared, and the samples of the respective types were tasted by approximately 30 persons who were asked to complete a survey regarding the flavor thereof.

Answers to survey questions were categorized as being of three types (A, B, and C). Answers of Type A were along the lines of “It is either unlike hummus or does not taste good because the smell or flavor of sake or sake lees is too strong”. Answers of Type B were along the lines of “It is like hummus and tastes good because the smell and flavor of sake lees and soy pulp are suitably weak”. Answers of Type C were along the lines of “It is either unlike hummus or does not taste good because the smell or flavor of soy pulp or soybeans is too strong”.

In the drawing, the respective food samples are indicated on the horizontal axis. More specifically, for each wt % ratio in the base, the number of the working example or comparative example at TABLE 1 is indicated on the horizontal axis. In the drawing, the vertical axis is the fractional number of people whose answers were of a particular type, this being calculated as a fraction of the total number of people.

As a result of this test, the following can be said. Regarding Comparative Examples 1 and 2, as the sake lees or soy pulp (or soybean) flavor was too strong, no one considered either of these to taste good. Regarding Working Examples 1 through 9, there were persons who considered each of these to be a hummus-like product and to taste good. Regarding Working Examples 2 through 5, half or more of the persons considered these to be hummus-like products and to taste good. Regarding Working Examples 3 through 5, the majority of persons considered these to be hummus-like products and to taste good. Regarding Working Example 4, practically 100% of persons considered this to taste good. Here, at Working Examples 1 through 9, the wt % ratio of sake lees:soy pulp was 90:10 to 10:90, and the solids content wt % ratio thereof was 80:20 to 5:95. At Working Examples 2 through 5, the wt % ratio of sake lees:soy pulp was 80:20 to 50:50, and the solids content wt % ratio thereof was 65:35 to 30:70. At Working Examples 3 through 5, the wt % ratio of sake lees:soy pulp was 70:30 to 50:50, and the solids content wt % ratio thereof was 50:50 to 30:70. At Working Example 4, the wt % ratio of sake lees:soy pulp was 60:40, and the solids content wt % ratio thereof was 40:60.

In other words, evaluation of the blended ratio of sake lees and soy pulp in the base may be understood as follows. When the solids content wt % ratio (sake lees:soy pulp) of the base is 80:20 to 5:95 (wt % ratio is 90:10 to 10:90), it is possible to achieve a hummus-like product. When the solids content wt % ratio (sake lees:soy pulp) of the base is 65:35 to 30:70 (wt % ratio is 80:20 to 50:50), this is preferred as a hummus-like product. When the solids content wt % ratio (sake lees:soy pulp) of the base is 50:50 to 30:70 (wt % ratio is 70:30 to 50:50), this is a particularly preferred blended ratio for a hummus-like food. When the solids content wt % ratio (sake lees:soy pulp) of the base is 40:60 (wt % ratio is 60:40), this is ideal as a hummus-like product.

Results of Sensory Evaluation Testing Carried Out with Respect to Blended Amount of Food Oil

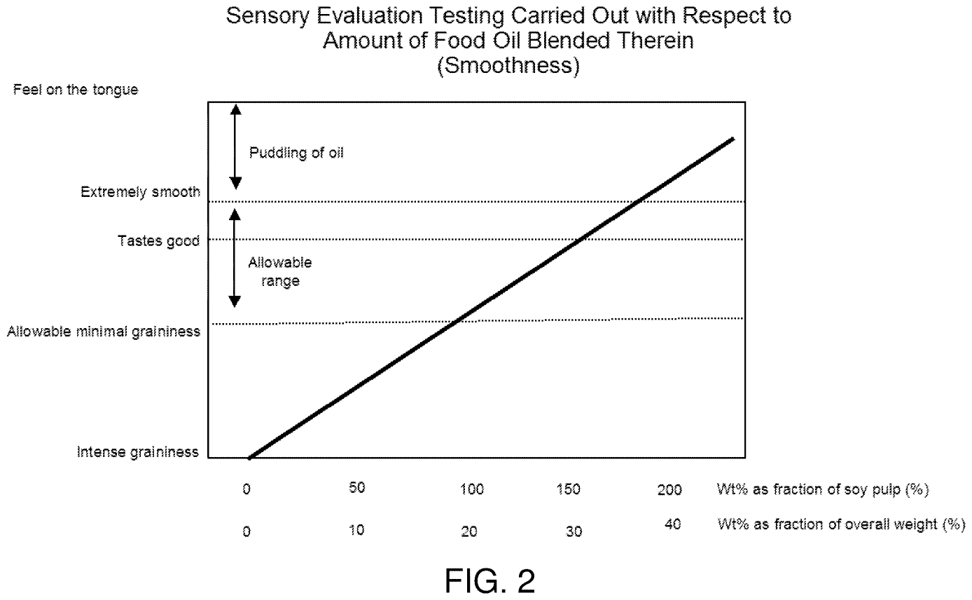

Sensory evaluation testing was carried out with respect to the amount of food oil that was blended therein. FIG. 2 shows results of sensory evaluation testing carried out with respect to the blended amount of food oil.

At this sensory evaluation testing, samples in which the amount of food oil blended therein as a fraction of the entirety was varied were tasted by approximately 30 persons who were asked to complete a survey regarding the smoothness thereof (how they felt on the tongue). Food oil is mostly absorbed by soy pulp, which affects the feel on the tongue of the food, i.e., the graininess or smoothness thereof. For each of three working examples in which the wt % ratio (wt % ratio in solids content) of sake lees:soy pulp in the base was varied (Working Example 3, Working Example 4, and Working Example 5), four types of samples in which food oil content as a fraction of the entirety was varied (0%, 10%, 20%, and 30%) were prepared.

In the drawing, food oil content as a fraction of the entirety is indicated on the horizontal axis. In the drawing, the feel on the tongue as reported by the majority (not less than 70% of 30 persons) of test subjects is indicated on the vertical axis. The lower on the vertical axis the greater the degree to which there was a perception of graininess, and the higher on the vertical axis the greater the degree to which there was a perception of smoothness. At the vertical axis, the range between “allowable minimal graininess” and “extremely smooth” was the range within which test subjects considered the sample to be an “allowable hummus-like food.”

Furthermore, the location within the allowable range which not less than 70% of test subjects reported as being perceived to be ideal is marked as “tastes good”.

Within the range marked “puddling of oil,” note that saturation of soy pulp by oil added thereto caused the excess added oil which was not absorbed thereby to pool, as a result of which not less than 70% of persons reported this to be not allowable.

As a result of the foregoing results, the following was learned. The range of fractional food oil contents perceived by persons to be allowable as a fraction of the overall weight of the hummus-like food (hereinafter referred to as “overall weight”) was approximately 20% to 40%. The fractional food oil content perceived by persons to be ideal as a fraction of overall weight was approximately 30%.

Note that the content of food oil relative to soy pulp solids content weight was 100% to 180% when fractional food oil content as a fraction of overall weight was within the range approximately 20% to 40%. Furthermore, the content of food oil relative to soy pulp solids content weight was 150% when fractional food oil content as a fraction of overall weight was approximately 30%.

What is claimed is:

1. A hummus-like food having a base;
wherein the base comprises sake lees and soy matter;
wherein fractional water content of the base is within a range that is 30% to 95%; and
wherein a wt % ratio of the sake lees to the soy matter present within solids content of the base is within a range that is 80:20 to 5:95.

2. The hummus-like food according to claim 1 wherein
the fractional water content of the base is within a range that is 70% to 90%; and
the wt % ratio of the sake lees to the soy matter present within the solids content of the base is within a range that is 65:35 to 10:90.

3. The hummus-like food according to claim 2 wherein
the wt % ratio of the sake lees to the soy matter present within the solids content of the base is within a range that is 50:50 to 30:70.

4. The hummus-like food according to claim 3 wherein
the wt % ratio of the sake lees to the soy matter present within the solids content of the base is 40:60.

5. The hummus-like food according to claim 1 further comprising food oil;
wherein content of the food oil as a fraction of overall weight is within a range that is 20% to 40%.

6. The hummus-like food according to claim 5 further comprising tahini (sesame paste) and a tartness-imparting substance.

7. The hummus-like food according to claim 1 wherein
the hummus-like food does not contain chickpeas that have been made into a paste.

8. A production method for a hummus-like food, the production method comprising:
an operation in which sake lees are heated and agitated;
an operation in which the sake lees are kneaded with soy matter, and fractional water content is adjusted so as to be within a range that is 30% to 95%, to produce a base; and
an operation in which food oil is kneaded into the base.

9. The hummus-like food according to claim 1 wherein the soy matter contains soy pulp but substantially no ground soybeans.

10. The hummus-like food according to claim 1 wherein the soy matter contains ground soybeans but substantially no soy pulp.

11. The hummus-like food according to claim 1 wherein the soy matter contains soy pulp and ground soybeans.

12. The production method according to claim 8 wherein the soy matter contains soy pulp but substantially no ground soybeans.

13. The production method according to claim 8 wherein the soy matter contains ground soybeans but substantially no soy pulp.

14. The production method according to claim 8 wherein the soy matter contains soy pulp and ground soybeans.
